(19) United States
(12) Patent Application Publication
(10) Pub. No.: US 2025/0300579 A1
(43) Pub. Date: Sep. 25, 2025

(54) Sensorless block commutation

(71) Applicant: Hilti Aktiengesellschaft, Schaan (LI)

(72) Inventor: Justus FREISCHLE, Landsberg (DE)

(21) Appl. No.: 18/863,132

(22) PCT Filed: May 15, 2023
(86) PCT No.: PCT/EP2023/062936

§ 371 Date: Nov. 5, 2024

(30) Foreign Application Priority Data
May 31, 2022 (EP) 22176269.3

(51) Int. Cl. H02P 6/15

(52) U.S. Cl. CPC H02P 6/157

(57) ABSTRACT

Method for the sensorless block commutation of a brushless DC motor, wherein a current sensor for detecting a current flowing through the DC motor, a detection circuit for detecting the zero crossings of the back-emf and a control unit are used, wherein the control unit is suitable for providing block control signals and position detection signals for a motor inverter assigned to the DC motor on the basis of the detected current and/or the zero crossings of the back-emf, wherein the block control signals are used for generating a propulsion force in order to drive a rotor of the DC motor causing it to rotate, and the position detection signals are used for detecting a rotor position of the rotor, and wherein the DC motor goes through a plurality of rotor position sectors in a runup phase prior to a normal operation phase being reached, and the control unit outputs exclusively position detection signals to the motor inverter in the runup phase.

The present invention relates to a method for sensorless block commutation of a brushless DC motor.

Devices and methods for sensorless block commutation are known in principle from the prior art.

U.S. Pat. No. 9,819,290 B2 describes an electric tool having a motor and a control unit which is designed for outputting detection signals and control signals for an inverter. The control unit determines, for mode control in a runup phase of the motor, the block control signals on the basis of position detection current components of a motor current.

U.S. Pat. No. 11,171,586 B2 discloses an electric tool having a control unit which is designed to identify an incorrect direction of rotor rotation by application of a first multiplicity of voltage pulses at a present motor sector and a second multiplicity of voltage pulses at a preceding sector.

### SUMMARY OF THE INVENTION

It is an object of the present invention to provide a method for sensorless block commutation of a DC motor which forms the basis of more accurate tracking of the rotor position of the DC motor.

The present invention provides that the control unit outputs exclusively position detection signals in the runup phase. In other words, the DC motor is rotated in the runup phase merely by position detection currents which are triggered by the position detection signals.

The invention includes the finding that, in the case of previously known commutation methods, a current signal detected by the current sensor in the runup phase contains both control current components and position detection current components. Although this enables a high runup torque, it does reduce the accuracy during tracking of the rotor position.

The invention furthermore includes the finding that changes in stator inductance can be used in the sensorless motor regulation in order to be able to detect and track the rotor position beneath the limit at which tracking is possible on the basis of BEMF-based methods. In this case, two basic physical properties of the motor can be used, namely saturation effects of the stator and/or saliency effects. A change, influenced by these properties, in the current signal detected by the current sensor preferably forms the basis of the method according to the invention.

In a particularly preferred configuration, the position detection signals have a plurality of primary pulses and a plurality of secondary pulses. It has been found to be advantageous if primary pulses and secondary pulses alternate. A primary pulse and a secondary pulse can have the same pulse duration. Alternatively, a primary pulse and a secondary pulse can have different pulse durations. It has been found to be advantageous if the same pause times are provided between the transition from primary pulse to secondary pulse or from secondary pulse to primary pulse. Alternatively, a respectively different pause time can be provided between the transition from primary pulse to secondary pulse or from secondary pulse to primary pulse. An alternate sequence of primary pulses and secondary pulses is defined as a pulse sequence.

In a particularly preferred configuration, a control state assigned to the present rotor position sector is used for the primary pulse, and a control state which is assigned to a next rotor position sector which directly follows the present rotor position sector in the direction of rotor rotation is used for the secondary pulse.

In a further particularly preferred configuration, a valid change in the rotor position sector is detected when the absolute value of a primary pulse current response to the primary pulse which is detected by the current sensor is greater than the absolute value of a secondary pulse current response to the secondary pulse which is detected by the current sensor. It has been found to be advantageous if the primary pulse current response to the primary pulse which is detected by the current sensor has a commutation current hysteresis on comparison with the secondary pulse current response to the secondary pulse which is detected by the current sensor. Only when the absolute value of the primary pulse current response is greater than the secondary pulse current response by the commutation current hysteresis is a valid change in the rotor position sector detected. This commutation current hysteresis can be adjustable. In a particularly preferred configuration of the method, provision is made for a preferably adjustable pause time, in which the motor phase currents completely decay, to be waited after detection of a valid change in the rotor position sector. After the pause time, a next pulse sequence is begun.

It has been found to be advantageous that, if a valid change in the rotor position sector is detected, the control states of the primary pulse and the secondary pulse are incremented or decremented, i.e. are switched over to the respective next rotor position sector. It has been found to be advantageous if a switchover only takes place if a minimum number of primary pulses and/or secondary pulses per pulse sequence have been injected. Alternatively or in addition, provision can be made for a switchover to only take place if a maximum number of pulse injections of primary pulses and/or secondary pulses per pulse sequence has not been exceeded. In a further particularly preferred configuration, the present rotor speed itself is determined in each case over the time period of the injection of a pulse sequence. Each pulse sequence can be valid for a rotor position sector, preferably 60°. From these two pieces of information, with knowledge of the pole pair number of the motor, the mechanical speed can be determined uniquely.

In a further particularly preferred configuration, provision is made for a direction detection pulse to be output as position detection signal once if a valid change in the rotor position sector is detected, wherein a control state which is assigned to a rotor position sector which directly precedes the present rotor position sector in the direction of rotor rotation is used for the direction detection pulse.

In a particularly preferred configuration, at the beginning of the runup phase, when the rotor is stationary, an initial rotor position detection takes place which does not generate a resultant rotor torque.

It has been found to be advantageous if the normal operation phase begins as soon as the rotor speed reaches a value which is in the range of from 1000 rpm to 3000 rpm. In a particularly preferred configuration, a commutation of the brushless DC motor in the normal operation phase takes place exclusively by means of block commutation. In a further particularly preferred configuration, the commutation of the DC motor in the normal operation phase takes place on the basis of a determination of the zero crossings of the back-emf.

The object is likewise achieved by an electric handheld power tool having a brushless DC motor, a current sensor for detecting a current flowing through the DC motor, a detection circuit for detecting the zero crossings of the back-emf and a control unit. The control unit is designed to provide block control signals and position detection signals for a motor inverter assigned to the DC motor on the basis of the detected current and/or the zero crossings of the back-emf, wherein the block control signals are used for generating a propulsion force in order to drive a rotor of the DC motor causing it to rotate, and the position detection signals are used for detecting a rotor position of the rotor. The DC motor is furthermore designed to go through a plurality of rotor position sectors in a runup phase prior to a normal operation phase being reached. In accordance with the invention, the control unit is designed to output exclusively position detection signals to the motor inverter in the runup phase.

The electric handheld power tool can be developed in a corresponding manner by the features described with reference to the method. The method according to the invention can also be implemented in other devices equipped with a brushless DC motor, such as, for example, in a vacuum cleaner or chipping hammer.

In a particularly preferred configuration, the brushless DC motor has a three-phase design and has six sectors each having 60° in the electrical reference system. Correspondingly, the motor inverter is configured for commutation of a three-phase DC motor. This motor inverter therefore has three half-bridges each having two power semiconductors per half-bridge. It has been found to be advantageous if the brushless DC motor is delta-connected. Alternatively, the brushless DC motor can be star-connected. Further advantages result from the following description of the figures. Various exemplary embodiments of the present invention are illustrated in the figures. The figures, the description and the claims contain numerous features in combination. A person skilled in the art will expediently also consider the features individually and combine them to form sensible further combinations.

### BRIEF DESCRIPTION OF THE DRAWINGS

Identical and functionally identical components are denoted by the same reference signs in the figures. In the drawings:

FIG. 1 shows a first exemplary embodiment of a handheld power tool according to the invention;

FIG. 2 shows a first exemplary embodiment of a method according to the invention;

FIG. 3 shows a second exemplary embodiment of a method according to the invention;

FIG. 4 shows an initial rotor position detection in the method in FIG. 2; and

FIG. 5 shows an alternative method for initial rotor position detection.

### DETAILED DESCRIPTION

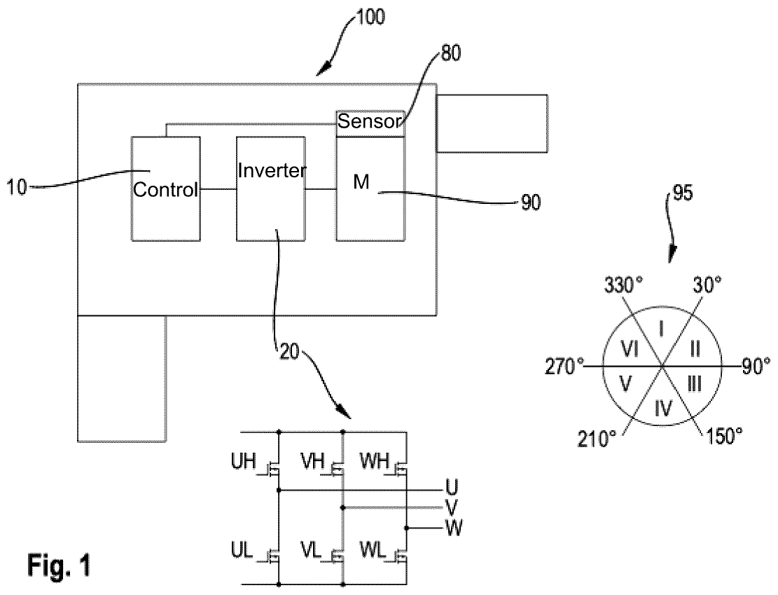

FIG. 1 shows—in a highly schematized form—an electric handheld power tool 100. The handheld power tool 100 is equipped with a brushless DC motor 90. The brushless DC motor 90 has a three-phase design and has a rotor 95 having six rotor position sectors I, II, III, IV, V, VI each having 60°. A current sensor 80 for detecting a current flowing through the DC motor 90 is assigned to the DC motor 90. In addition, a circuit for zero crossing identification of the back-emf 70 is provided.

A motor inverter 20 is connected upstream of the DC motor 90 and in this case has six FETs (field-effect transistors), wherein in each case two FETs are provided per phase U, V, W. The electric handheld power tool 100 furthermore has a control unit 10, which is designed to provide block control signals and position detection signals for the motor inverter 20 on the basis of the current detected by means of the current sensor 80 and/or the zero crossings of the back-emf. The block control signals are used (In a manner known from the prior art) for generating a propulsion force in order to drive the rotor 95 causing it to rotate. The position detection signals are used to detect a rotor position of the rotor 95. In accordance with the invention, the control unit 10 is designed to output, in a runup phase, i.e., for example, up to a speed of the DC motor of 2000 rpm, exclusively position detection signals to the motor inverter 20, which will be explained more precisely with reference to the following figures.

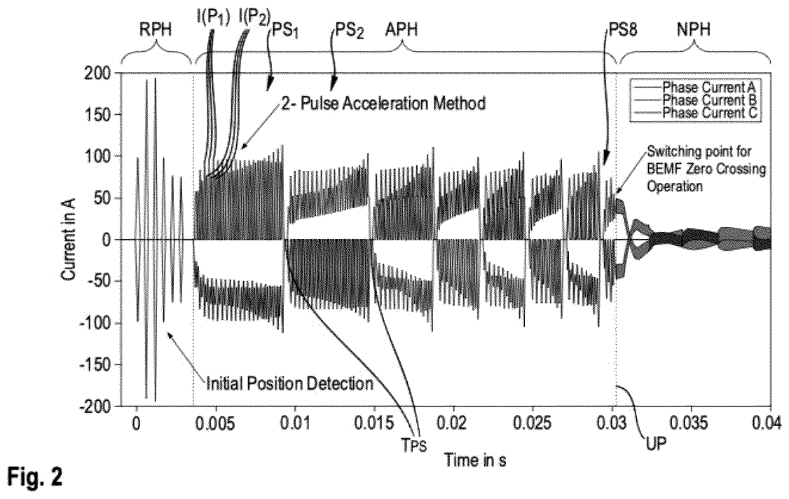

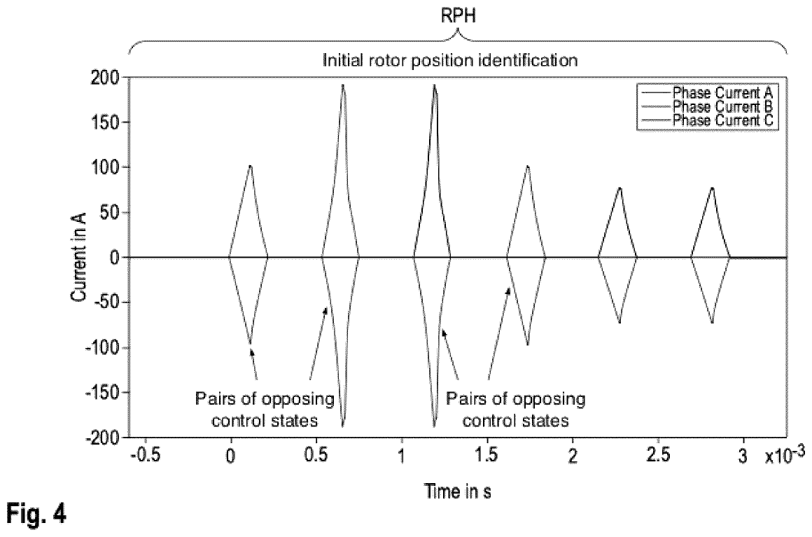

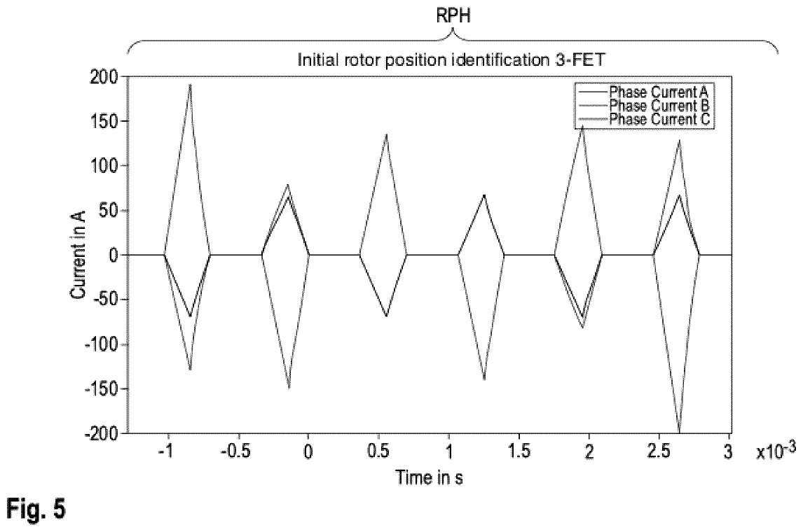

FIG. 2 shows a graph of the characteristic over time of the phase currents A, B, C (corresponding to phase U, V, W in FIG. 1) detected by means of three current sensors. The graph is split into an initial position detection/rest phase IPD/RPH, a runup phase APH and a normal operation phase NPH. During the initial position detection/rest phase IPD/RPH, the rotor is at a standstill. The initial rotor position detection will be explained more precisely later with reference to FIGS. 4 and 5.

In the runup phase APH, which directly follows the initial position detection and lasts for up to approximately 30 milliseconds, for example, a determination of a zero crossing of the back-emf (BEMF zero crossing identification) as a basis for the sensorless block commutation of the DC motor 90 is not reliably possible. Here begins the invention, which provides that the control unit outputs exclusively position detection signals to the motor inverter in the runup phase APH.

Within the scope of the method, two voltage pulses, namely a primary pulse and a secondary pulse, are injected alternately as position detection signals to the motor inverter 20, and the resultant current amplitudes are detected and compared. Therefore, this method can also be referred to as a “2-pulse acceleration method”. By virtue of the injected primary pulses and secondary pulses, a resultant torque is generated which sets the rotor in rotation.

Correspondingly, the graph in FIG. 2 shows the primary pulse current responses I(P1) alternating with the secondary pulse current responses I(P2). A control state of the motor inverter which is assigned to the present rotor position sector is used for the primary pulse. A control state which is assigned to a next rotor position sector which directly follows the present rotor position sector in the direction of rotor rotation is used for the secondary pulse. The primary pulse current responses I(P1) and the secondary pulse current responses I(P2) change with the rotor position, which can be attributed to the saturation effects or saliency effects mentioned at the outset.

If the primary pulse current response I(P1) of the primary pulse has a greater amplitude than the secondary pulse current response I(P2) of the secondary pulse, the rotor is in the next rotor position sector. Here, for robustness reasons, in addition an adjustable commutation current hysteresis IHys is used and is applied to the secondary pulse current response I(P2). Accordingly, a valid change in the rotor position sector is detected when the condition primary pulse current response I(P1)>secondary pulse current response I(P2)+commutation current hysteresis IHys is met. If such a valid change in the rotor position sector is detected, the control states of the primary pulse and the secondary pulse are incremented or decremented. One first pulse sequence PS1 is concluded. Then, an adjustable pause time TPS is waited. In this pause time TPS, the motor phase currents need to completely decay, as is illustrated in FIG. 2. If the pause time TPS has elapsed, the next pulse sequence, in this case the second pulse sequence PS2, is begun. In the runup phase (APH) shown in FIG. 2, for example, eight pulse sequences exist. At the end of the eighth pulse sequence PS8, a switchover time (UP) is present at which the normal operation phase (NPH) of the DC motor begins. A commutation of the brushless DC motor takes place from this switchover time (UP) on exclusively by means of block commutation. The commutation of the DC motor in the normal operation phase takes place on the basis of a determination of the zero crossings of the back-emf.

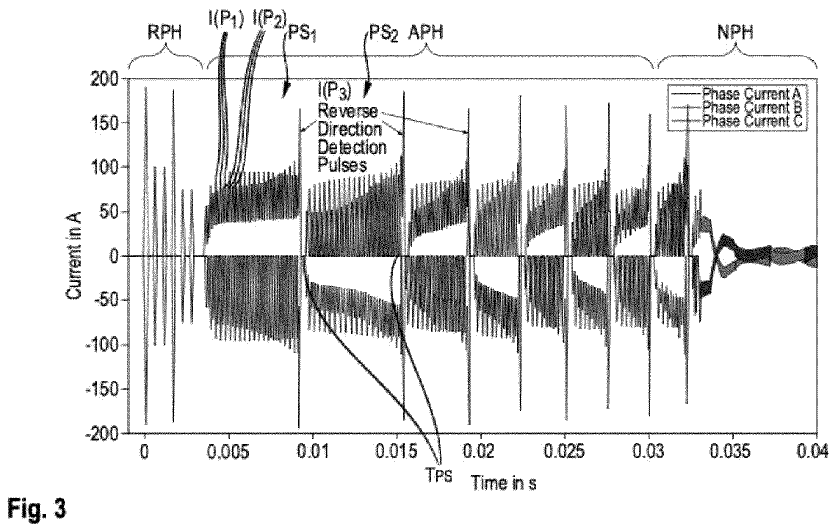

FIG. 3 shows the so-called “3-pulse acceleration method”, in which, in addition to the method described with reference to FIG. 2, a direction detection pulse is output as position detection signal to the motor inverter once in each pulse sequence (PS). Such a direction detection pulse in each case effects a direction detection pulse current response I(P3) shown in FIG. 3. In each case one control state which is assigned to a rotor position sector which directly precedes the present rotor position sector in the direction of rotor rotation is used for the direction detection pulse. A direction detection pulse is in each case injected when a valid change in the rotor position sector is detected corresponding to the description of FIG. 2.

If the direction detection pulse current response I(P3) of the direction detection pulse has a greater amplitude than the last-measured primary pulse current response I(P1) of the primary pulse, the rotor rotates in the desired direction. Here, for robustness reasons, in addition an adjustable directional current hysteresis IHysRi is used and is applied to the primary pulse current response I(P1). Accordingly, a rotation of the rotor in the desired direction of rotation is detected when the condition direction detection pulse current response I(P3)>primary pulse current response I(P1)+directional current hysteresis IHysRi is met. Otherwise, it is a rotation of the rotor in the undesired direction of rotation.

The methods described with reference to FIGS. 2 and 3 can be supplemented in each case by an initial rotor position detection. This will now be explained more precisely with reference to FIGS. 4 and 5.

FIGS. 4 and 5 each show a graph of the characteristic over time of the phase currents A, B, C (corresponding to phase U, V, W in FIG. 1) detected by means of three current sensors. The initial rotor position detection takes place in a rest phase RPH, which temporally precedes the runup phase APH (cf. FIGS. 2 and 3). In the rest phase RPH, the rotor is at a standstill.

An initial rotor position detection preferably takes place in such a way that in each case pairs of opposing control states are injected in order to generate, on average, no resultant torque. After the pulse injection, pause times are provided so that the currents induced can decay completely before the next pulse is injected.

In the case of the initial rotor position detection, preferably the same physical properties are used which also come to bear in the runup phase APH. In the case of the initial rotor position detection, so to speak differences in the current responses of the injected voltage pulses are used in order to be able to draw a conclusion on the initial rotor position. However, in the case of specific rotor positions, more precisely the sector limits of the detection, there is an angular uncertainty of 60° (a rotor position sector). At these positions, a measurement noise of the current measurement can already result in an erroneous detection of the initial rotor position by a rotor position sector. It has been found to be advantageous if, in order to minimize the frequency of an erroneous determination of the initial rotor position, the rest positions of the brushless DC motor do not correspond to the detection sector limits of the method. This can be because the magnetic system of the DC motor strives for the lowest magnetic resistance (reluctance) and this is met at the magnetic rest positions of the motor. Therefore, the rest positions represent the most frequent rotor positions during the initial rotor position detection. Furthermore, the orientations of the injected voltage phasors are determined by the (star or delta) connection of the motor. The orientations of the injected voltage phasors differ between a star connection and a delta connection by 30°.

The method according to the invention and/or the device according to the invention can envisage the use of a 3-FET block commutation or 2-FET block commutation depending on the electrical connection of the brushless DC motor (star or delta). These two control systems differ from one another in that they have different control states and therefore inject voltage pulses which differ by 30°. As a result, the difference in the connection can be compensated for. The detection limits can therefore always be separated from the magnetic rest positions. This provides the advantage that the above-described detection algorithm can remain unchanged. The invention in this regard includes the finding of using different control states in order to separate the detection limits of the method from the magnetic rest positions of the motor depending on the connection.

FIG. 4 shows an initial rotor position detection for a star-connected brushless DC motor which has a three-phase design and has 6 sectors each having 60° in the electrical reference system. For this motor connection, it is advantageous in the case of the initial rotor position detection if the motor inverter during a position detection pulse has three active power semiconductors (3-FET).

FIG. 5 shows an initial rotor position detection for a delta-connected brushless DC motor which has a three-phase design and has 6 sectors each having 60° in the electrical reference system. For this motor connection, it is advantageous in the case of the initial rotor position detection if the motor inverter during a position detection pulse has two active power semiconductors (2-FET).

### LIST OF REFERENCE SIGNS

10 control unit
20 motor inverter
70 BEMF zero crossing detection circuit
80 current sensor
90 brushless DC motor (BLDC motor)
95 rotor
100 electric handheld power tool
I, II, VI rotor position sectors
IPD initial rotor position detection
APH runup phase
I(P1) primary pulse current response
I(P2) secondary pulse current response
I(P3) direction detection pulse current response
IHys commutation current hysteresis
IHysRi directional current hysteresis
NPH normal operation phase
RPH rest phase
PS1, PS2 pulse sequence
U, V, W phases of the DC motor
UP switchover time
TPs pause time

What is claimed is:

1-12. (canceled)

13. A method for the sensorless block commutation of a brushless DC motor, a current sensor for detecting a current flowing through the DC motor, a detection circuit for detecting the zero crossings of a back-emf and a control unit being used, wherein the control unit is suitable for providing block control signals and position detection signals for a motor inverter assigned to the DC motor on the basis of the detected current or the zero crossings of the back-emf, the method comprising:
using block control signals for generating a propulsion force in order to drive a rotor of the DC motor causing the rotor to rotate; and
using the position detection signals for detecting a rotor position of the rotor, and wherein the DC motor goes through a plurality of rotor position sectors in a runup phase prior to a normal operation phase being reached, the control unit outputting exclusively the position detection signals to the motor inverter in the runup phase.

14. The method as recited in claim 13 wherein the position detection signals have a singular or a plurality of primary pulses and a singular or a plurality of secondary pulses.

15. The method as recited in claim 14 wherein the primary pulses and the secondary pulses alternate.

16. The method as recited in claim 14 wherein a control state assigned to a present rotor position sector is used for the primary pulse, and a second control state assigned to a next rotor position sector directly following the present rotor position sector in the direction of rotor rotation is used for the secondary pulse.

17. The method as recited in claim 14 wherein a valid change in the rotor position sector is detected when an absolute value of a primary pulse current response to the primary pulse detected by the current sensor is greater than an absolute value of a secondary pulse current response to the secondary pulse detected by the current sensor.

18. The method as recited in claim 17 wherein, if a valid change in the rotor position sector is detected, the control states of the primary pulse and the secondary pulse are incremented or decremented.

19. The method as recited in claim 17 wherein a direction detection pulse is output as position detection signal once if a valid change in the rotor position sector is detected, wherein a control state assigned to a rotor position sector directly preceding the present rotor position sector in the direction of rotor rotation is used for the direction detection pulse.

20. The method as recited in claim 13 wherein, at the beginning of the runup phase, when the rotor is stationary, an initial rotor position detection takes place which does not generate a resultant rotor torque.

21. The method as recited in claim 13 wherein the normal operation phase begins as soon as a rotor speed reaches a value which is in the range of from 1000 rpm to 3000 rpm.

22. The method as recited in claim 13 wherein a commutation of the brushless DC motor in the normal operation phase takes place exclusively by means of block commutation.

23. The method as recited in claim 13 wherein the commutation of the DC motor in the normal operation phase takes place on the basis of a detection of the zero crossings of the back-emf.

24. An electric handheld power tool comprising:
a brushless DC motor;
a current sensor for detecting a current flowing through the DC motor;
a detection circuit for detecting the zero crossings of the back-emf, and
a control unit designed to provide block control signals and position detection signals for a motor inverter assigned to the DC motor on the basis of the detected current or the zero crossings of the back-emf, wherein the block control signals are used for generating a propulsion force in order to drive a rotor of the DC motor causing the rotor to rotate, and the position detection signals are used for detecting a rotor position of the rotor, and wherein the DC motor is designed to go through a plurality of rotor position sectors in a runup phase prior to a normal operation phase being reached, the control unit designed to output exclusively the position detection signals to the motor inverter in the runup phase.
